(19) United States
(12) Patent Application Publication
(10) Pub. No.: US 2009/0232087 A1
(43) Pub. Date: Sep. 17, 2009

(54) User Equipment Multiplexing In Downlink Multiuser, Multiple Input Multiple Output Orthogonal Frequency Division Multiple Access

(75) Inventors: Runhua Chen, Dallas, TX (US); Eko N. Onggosanusi, Allen, TX (US); Zukang Shen, Richardson, TX (US); Badri N. Varadarajan, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incomrporated, Dallas, TX (US)

(21) Appl. No.: 12/400,120

(22) Filed: Mar. 9, 2009

Related U.S. Application Data
(60) Provisional application No. 61/034,851, filed on Mar. 7, 2008.

(51) Int. Cl. H04W 72/04; H04L 27/28

(52) U.S. Cl. 370/330; 375/260

(57) ABSTRACT

This invention is a method of downlink, multiuser, multiple input, multiple output communication between a single base station and plural user equipment. Resource buffers are distributed into sub-bands. Each user equipment is assigned to a sub-band with at least one sub-band assigned plural user equipment. The base station transmits user equipment according to assigned sub-bands. A single user equipment may be assigned one sub-band while plural user equipment are assigned to another sub-band. In one embodiment the base station has N transmit antennas. N user equipment is assigned to a first sub-band and less than N user equipment is assigned to a second sub-band. In another embodiment a first second user equipment is assigned a first sub-band and the first and a third user equipment are assigned to a second sub-band.

### CLAIM OF PRIORITY

This application claims priority under 35 U.S.C. 119(e)(1) to U.S. Provisional Application No. 61/034,851 filed Mar. 7, 2008.

### TECHNICAL FIELD OF THE INVENTION

The technical field of this invention is wireless communication.

### BACKGROUND OF THE INVENTION

FIG. 1 shows an exemplary wireless telecommunications network 100. The illustrative telecommunications network includes base stations 101, 102 and 103, though in operation, a telecommunications network necessarily includes many more base stations. Each of base stations 101, 102 and 103 are operable over corresponding coverage areas 104, 105 and 106. Each base station's coverage area is further divided into cells. In the illustrated network, each base station's coverage area is divided into three cells. Handset or other user equipment 109 is shown in Cell A 108. Cell A 108 is within coverage area 104 of base station 101. Base station 101 transmits to and receives transmissions from user equipment 109. As user equipment 109 moves out of Cell A 108 and into Cell B 107, user equipment 109 may be handed over to base station 102. Because user equipment 109 is synchronized with base station 101, user equipment 109 can employ non-synchronized random access to initiate handover to base station 102.

Non-synchronized user equipment 109 also employs non-synchronous random access to request allocation of up-link 111 time or frequency or code resources. If user equipment 109 has data ready for transmission, which may be traffic data, measurements report, tracking area update, user equipment 109 can transmit a random access signal on up-link 111. The random access signal notifies base station 101 that user equipment 109 requires up-link resources to transmit the user equipment's data. Base station 101 responds by transmitting to user equipment 109 via down-link 110, a message containing the parameters of the resources allocated for user equipment 109 up-link transmission along with a possible timing error correction. After receiving the resource allocation and a possible timing advance message transmitted on down-link 110 by base station 101, user equipment 109 optionally adjusts its transmit timing and transmits the data on up-link 111 employing the allotted resources during the prescribed time interval.

A downlink multiuser, multiple input, multiple output MIMO (DL MU-MIMO) communication system involves a single base station transmitting to multiple UEs at the same time over the same frequency bandwidth. One example of a DL MU-MIMO scheme is the dirty-paper coding technique. From an information theory perspective this dirty-paper coding technique is the optimal MU-MIMO scheme in terms of achieving the maximum sum capacity. An alternative and more practical MU-MIMO technique is transmit preceding. In transmit preceding the data to each UEs is multiplied to a UE-specific preceding matrix and then transmitted at the base station antenna array simultaneously.

In an orthogonal frequency division multiple access (OFDMA) system, system bandwidth is divided into a number of sub-bands each consisting of a set of subcarriers. The number and indices of UEs supported by DL MU-MIMO on a particular sub-band can be different.

### SUMMARY OF THE INVENTION

This invention is a method of downlink, multiuser, multiple input, multiple output communication between a single base station and plural user equipment. The time/frequency available to the base station is divided into a plurality of resource blocks. These resource buffers are distributed into sub-bands. Each user equipment is assigned to a sub-band with at least one sub-band assigned plural user equipment. The base station transmits user equipment according to assigned sub-bands.

A single user equipment is assigned one or multiple sub-band, where these sub-bands can be consecutive or non-adjacent in frequency domain. Plural user equipment is assigned to another sub-band. It is possible to assign a single user equipment on one sub-band, and multiple user equipment on another sub-band. For example, a first user equipment solely to a first sub-band and the first user equipment and at least one other is assigned a second sub-band.

In one embodiment the base station has N transmit antennas. N user equipment is assigned to a first sub-band. A single codeword/data stream is assigned to each of these user equipment. These are operated with rank 1, where rank denotes the number of data layers in a codeword. Less than N user equipment is assigned to a second sub-band. The user equipment assigned to the second sub-band includes operating with rank greater than 1 including multiple data layers for each user equipment assigned to the second sub-band. The sum of the operating rank of each user equipment assigned to the second sub-band is less than or equal to N.

In another embodiment a first second user equipment is assigned a first sub-band and the first and a third user equipment are assigned to a second sub-band.

### BRIEF DESCRIPTION OF THE DRAWINGS

These and other aspects of this invention are illustrated in the drawings, in which:

FIG. 1 is a diagram of a communication system of the present invention having three cells;

FIG. 2 illustrates the total operating bandwidth divided into a number of resource blocks (sub-bands) according to the prior art; and

FIG. 3 is an example of user equipment multiplexing in downlink multiuser, multiple input multiple output according to this invention.

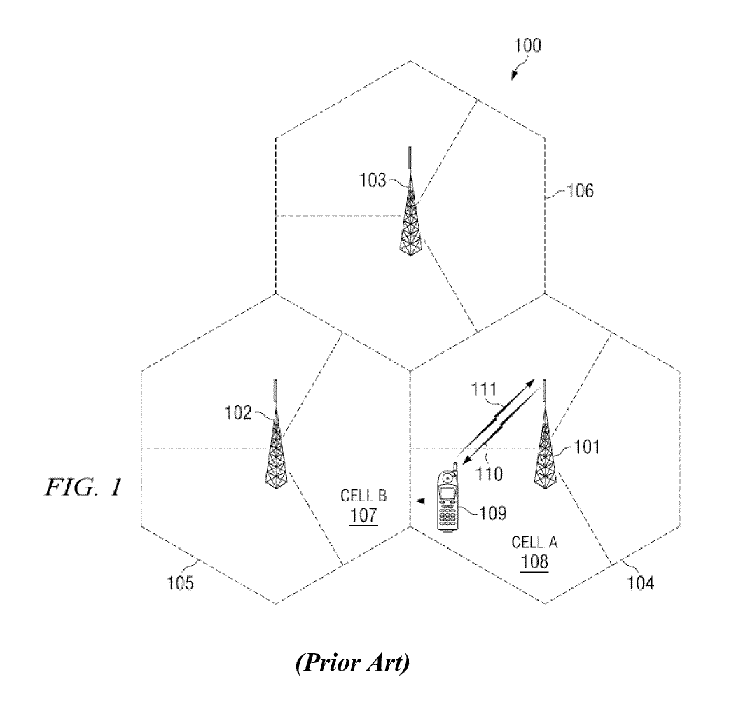

### DETAILED DESCRIPTION OF PREFERRED EMBODIMENTS

This invention concerns a MU-MIMO system in the multi-carrier OFDMA context. The operating bandwidth is divided into non-overlapping resource blocks (RB).

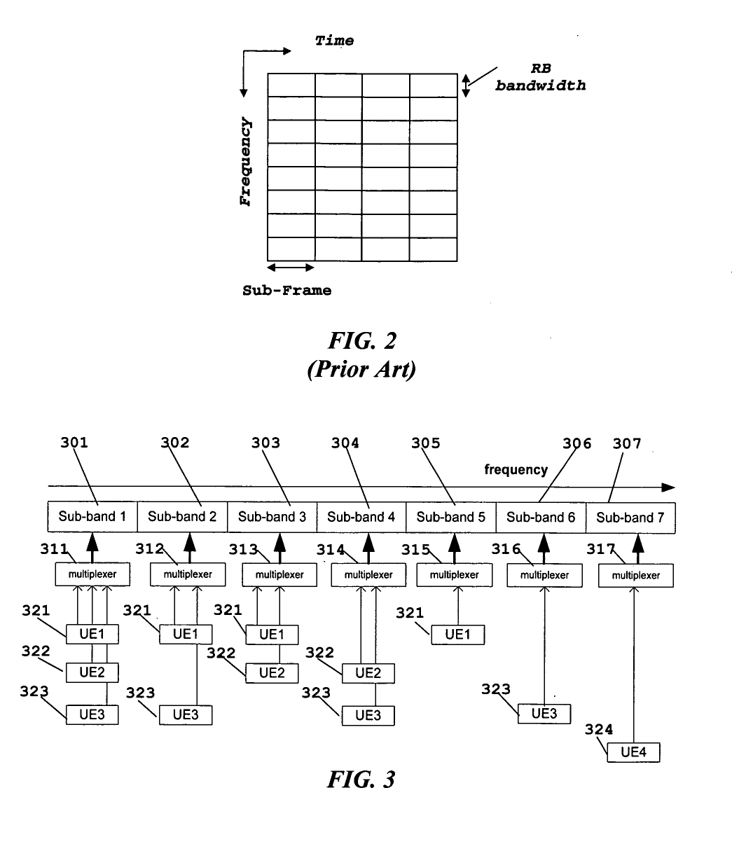

FIG. 2 illustrates division of operating bandwidth in non-overlapping RBs. In FIG. 2 the total resources available to the base station is divided in frequency into RB bandwidths and in time into sub-frames. This divides the operating time/bandwidth into M RBs. A resource block is set of adjacent sub-carriers (tones). In the LTE (Long Term Evolution) Rel-8, a 5 MHz bandwidth has 25500 RBs of 180 KHz each. The total operating bandwidth is 4.5 MHz after allowing 0.5 MHz bandwidth to be used for band edge interference protection. For scheduling purposes, RBs may be concatenated into larger blocks. Such an entity is defined as a sub-band. One sub-band consists of n RBs, where n is a positive integer. Assume the system bandwidth provides N sub-bands. While all the N sub-bands may include the same number of RBs, it is also possible for different sub-bands to have different numbers of RBs. This is particularly relevant when M is not a multiple of N.

At a particular time instant and on a particular sub-band, the serving base station can simultaneously transmit to multiple UEs. These multiple UEs are multiplexed in the spatial domain. Data to each UE will be modulated by a preferred preceding matrix from a codebook known a priori to both the base station and the UEs. A particular UE can be scheduled on a number of consecutive or adjacent sub-bands.

In accordance with this invention for the n-th sub-band, the number of UEs multiplexed is denoted by Nu (n). The indices of the multiplexed UE is represented by U=[X(n, 1), X(n, 2) . . . X(n, Nu(n))].

FIG. 3 illustrates an example of a possible logical organization according to this invention. The number of UEs multiplexed on a sub-band can be sub-band specific. A different number of UEs can be multiplexed on different sub-bands. FIG. 3 illustrates sub-band 1 301, sub-band 2 302, sub-band 3 303, sub-band 4 304, sub-band 5 305, sub-band 6 306 and sub-band 6 306. In FIG. 3 the base station can transmit to: three UEs (UE1 321, UE2 321 and UE3 323) on sub-band 1 301 via multiplexer 311; to two UEs (UE1 321 and UE3 323) on sub-bands 2 302 via multiplexer 312; to two UEs (UE1 321 and UE3 323) on sub-band 303 via multiplexer 313; to two UEs (UE2 322 and UE3 323) via multiplexer 314; to only one UE (UE1 321) on sub-band 5 305 via multiplexer 315; to only one UE (UE3 323) on sub-band 6 306 via multiplexer 316; and to only one UE (UE4 324) on sub-band 7 307 via multiplexer 317. This invention does permits the same number of UEs to be multiplexed on different sub-bands, such as UE1 321 and UE2 322 on sub-band 3 303 and UE2 322 and UE3 323 on sub-band 4 304.

The base station may transmit to a single UE on one sub-band making Nu=1. FIG. 3 illustrates this for sub-band 5 305, sub-band 6 306 and sub-band 7 307. The base station may transmit to multiple UEs on a different sub-band where Nu>1. FIG. 3 illustrates this for sub-band 1 301, sub-band 2 302, sub-band 3 303 and sub-band 4 304. The system may operate in the single-user MIMO (SU-MIMO) mode on certain sub-bands supporting only one UE and also operate in MU-MIMO mode on other sub-bands supporting multiple UEs.

A UE may operate in SU-MIMO and MU-MIMO mode simultaneously in different sub-bands. In the example illustrated in FIG. 3, UE1 321 is in MU-MIMO mode in sub-band 1 301 multiplexed via multiplexer 311 with UE2 322 and UE3 303 and in SU-MIMO model in sub-band 5 305. FIG. 3 illustrates the example of UE4 324 operating only in SU-MIMO mode in sub-band 307. FIG. 3 also illustrates the example of UE2 322 operating only in MU-MIMO mode in sub-band 1 301, sub-band 3 303 and sub-band 4 304.

The maximum number of UEs that can be multiplexed on a sub-band is equal to the number of transmit antennas Nₜ at the serving base station. For example, a MU-MIMO system with 4 transmit antennas may communicate with a maximum of 4 UEs simultaneously in the downlink on a given sub-band. In this case, each UE operates in rank-1 transmission where a single codeword codeword/data sub-stream is targeted for transmission to this UE. On a sub-band where the number of multiplexed UEs is less than Nₜ, the UE rank may be equal to or greater than 1. The summation of the ranks of all UEs multiplexed on a sub-band should be equal to or less than Nₜ.

For a particular UE, the indices of other UEs that share the same sub-band could be sub-band specific. This means that a UE can be grouped with different UEs on different sub-bands. In the example illustrated in FIG. 3 assume UE1 321 is target UE. FIG. 3 illustrates that UE1 321 can be paired with UE3 323 in sub-band 2 302 and paired with UE2 322 in sub-band 3 303.

What is claimed is:

1. A method of downlink, multiuser, multiple input, multiple output communication between a single base station and plural user equipment comprising the steps of:
dividing the time/frequency available to the single base station into a plurality of resource blocks having a predetermined sub-frame time and a predetermined frequency bandwidth;
distributing the resource buffers into a plurality of sub-bands, each sub-band assigned at least on resource block;
assigning the user equipment to the sub-bands with at least one sub-band assigned plural user equipment; and
transmitting from the base station to the plural user equipment according to the assigned sub-bands.

2. The method of claim 1, wherein:
said step of assigning user equipment to the sub-bands assigns a single user equipment to at least one sub-band.

3. The method of claim 1, wherein:
said step of assigning user equipment to the sub-bands assigns
a single user equipment to a first sub-band, and
a plurality of user equipment to a second sub-band.

4. The method of claim 1, wherein:
said step of assigning user equipment to the sub-bands assigns
a first user equipment solely to a first sub-band, and
the first user equipment and at least one other user equipment to a second sub-band.

5. The method of claim 1, wherein:
the base station has N number of transmit antennas; and
said step of assigning user equipment to the sub-bands assigns N user equipment to a first sub-band.

6. The method of claim 5, wherein:
said step of transmitting on the first sub-band includes assigning a single codeword/data stream to each user equipment assigned to the first sub-band, and
operating with rank 1 having one data layer in a codeword for each user equipment assigned to the first sub-band.

7. The method of claim 1, wherein:
the base station has N number of transmit antennas;
said step of assigning user equipment to the sub-bands assigns less than N user equipment to a first sub-band; and
said step of transmitting on the first sub-band includes operating with rank greater than or equal to 1 having one or more data layers in a codeword for each user equipment assigned to the first sub-band.

8. The method of claim 7, wherein:
the sum of the operating rank of each user equipment assigned to the second sub-band is less than or equal to N.

9. The method of claim 1, wherein:
said step of assigning user equipment to the sub-bands assigns
a first user equipment and a second user equipment to a first sub-band, and
the first user equipment and a third user equipment to a second sub-band.
